(19) United States
(12) Patent Application Publication
(10) Pub. No.: US 2018/0342001 A1
(43) Pub. Date: Nov. 29, 2018

(54) Systems and Methods for Use in Personalizing Vehicles Based on User Profiles

(71) Applicant: MASTERCARD INTERNATIONAL INCORPORATED, Purchase, NY (US)

(72) Inventor: Pedro Chavarria, New York, NY (US)

(21) Appl. No.: 15/606,075

(22) Filed: May 26, 2017

(51) Int. Cl. G06Q 30/06; G06Q 20/10; G06F 21/32

(52) U.S. Cl. CPC G06Q 30/0621; G06F 21/32; G06Q 20/10

(57) ABSTRACT

Disclosed are exemplary embodiments of systems and methods for use in personalizing a vehicle to a user. One exemplary method includes authenticating a user to a vehicle where the user is associated with a payment account and, after the user is authenticated, loading, by a computing device, a profile associated with the user to the vehicle where the profile includes a payment credential associated with the payment account and at least one vehicle control. The method also includes imposing, by the computing device, the at least one vehicle control on a feature of the vehicle to thereby alter the feature of the vehicle and providing, by the computing device, the payment credential to a merchant in connection with a transaction associated with the vehicle.

### FIELD

The present disclosure generally relates to systems and methods for use in personalizing vehicles based on user profiles, and in particular, to authenticating users to vehicles, and thereafter, loading user profiles for the authenticated users to the vehicles.

### BACKGROUND

This section provides background information related to the present disclosure which is not necessarily prior art.

Consumers are known to purchase products (e.g., good, services, etc.) from merchants. Often, the purchases are funded by payment accounts, such as, for example, credit accounts, debit accounts, prepaid account, etc., whereby the consumers present payment devices such as credit cards, payment applications, etc. to the merchants to initiate the purchase transactions. The merchants, in turn, obtain authorizations for the purchase transactions from issuers of the corresponding payment accounts. Once obtained, the merchants consider the transactions to be funded, and cause the products to be delivered to the consumers and/or allow the consumers to leave the merchant locations with the products.

Separately, consumers are known to operate vehicles, such as, for example, cars, trucks, etc., to travel between different locations. The vehicles include features that may be tuned to the individual consumers traveling within the vehicles. Such features may include positions of the seats, positions of steering wheels, settings of climate controls, etc.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in personalizing vehicles based on user profiles;

FIG. 2 is a block diagram of a computing device that may be used in the exemplary system of FIG. 1; and

FIG. 3 is a flow diagram of an exemplary method, suitable for use in the system of FIG. 1, for authenticating a user to a vehicle and, thereafter, loading a user profile for the authenticated user to the vehicle.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers (broadly, users) often purchase products (e.g., goods and services, etc.) from merchants through use of payment accounts. In addition, the consumers may use vehicles to travel from location to location (e.g., to a merchant location, etc.). The vehicles may be owned by the consumers, or they may be shared with one or more other users (e.g., a family vehicle, a rental vehicle, etc.). Uniquely, the systems and methods herein provide for personalization of vehicles to users, based on authentication of the users to the vehicles. In particular, a user may approach a vehicle and authenticate himself/herself to the vehicle. The vehicle, in turn, is then able to access a profile associated with the user and load the user profile to the vehicle. The user profile includes, generally, a payment credential associated with a payment account (e.g., issued to the user, etc.) and one or more vehicle controls. In connection therewith, the vehicle may then provide the payment credential to one or more merchants interacting with the vehicle (or with the user when in association with the vehicle), as desired by the user, to thereby fund a transaction between the merchant and the user (without the user having to separately provide the payment credential to the merchant). Similarly, the vehicle may implement the one or more vehicle controls at the vehicle (e.g., automatically moving a driver's seat to a preferred seat position for the user, etc.) for the user when in the vehicle. Subsequently, then, when the user arrives at a desired location, or is otherwise finished using the vehicle (e.g., and exits the vehicle, etc.), the user profile is unloaded from the vehicle, whereby the payment credential is no longer associated with the vehicle and the vehicle controls are no longer imposed on the vehicle. Thus, through the systems and methods herein, after initial authentication of users to vehicles, the vehicles are personalized to the users with predefined user preferences and are provisioned with payment credentials for the users. What's more, such personalization is available to the users regardless of whether the vehicles are individual to the users or are shared with other users.

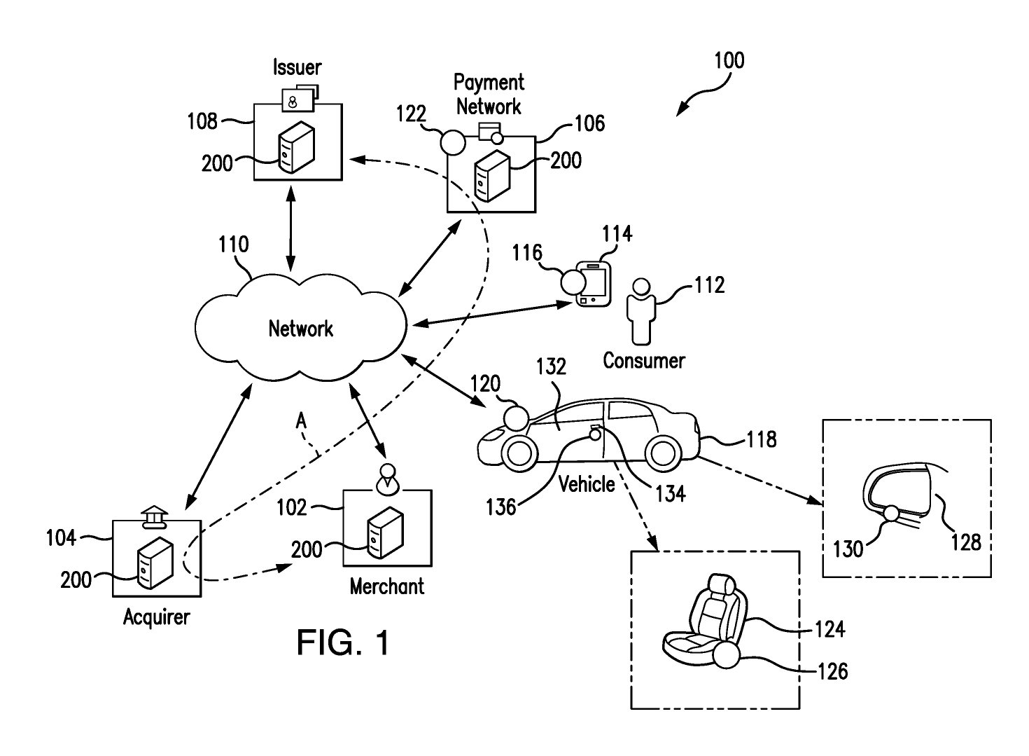

FIG. 1 illustrates an exemplary system 100, in which one or more aspects of the present disclosure may be implemented. Although, in the described embodiment, the system 100 is presented in one arrangement, other embodiments of the present disclosure may include the system 100 arranged otherwise depending, for example, on types of vehicles involved, processing of payment account transactions, connectivity associated with vehicles, interactions between vehicles and payment networks, etc.

Referring to FIG. 1, the system 100 generally includes, in connection with facilitating payment account transactions, a merchant 102, an acquirer 104 associated with the merchant 102, a payment network 106, and an issuer 108 configured to issue payment accounts to consumers, each of which is coupled to network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In this example, the network 110 may include a private payment transaction network made accessible by the payment network 106 to the acquirer 104 and the issuer 108 and, separately, a public network (e.g., the Internet, etc.) through which the merchant 102 and the acquirer 104, and/or other parts of the system 100 (e.g., a vehicle 118, etc.), may communicate (e.g., via network-based applications, etc.).

In the system 100, the merchant 102 offers products (e.g., goods and/or services, etc.) for sale to consumers. In general, the merchant 102 is disposed to interact with consumers in association with and/or in connection with one or more vehicles operated by the consumers. In connection therewith, the merchant 102 may include any merchant with which consumers interact for products related to their vehicles, and/or with which consumers interact for products while in their vehicles and/or near their vehicles. For example, the merchant 102 may include a service station merchant disposed to provide fuel or oil products or car wash services, etc. to consumers for their vehicles. Or, the merchant 102 may include a toll operator disposed to collect tolls from the consumers for use of a tollway. Still further, the merchant 102 may include a drive-thru merchant at which consumers are able to purchase food or other products, etc. while in their vehicles or near their vehicles.

Also in the system 100, consumer 112 is associated with a payment account, which is issued by the issuer 108 to the consumer 112. The payment account includes a payment credential (or multiple payment credentials) (e.g., a primary account number (PAN), a token, etc.) that can be used by the consumer 112 to perform payment account transactions at desired merchants, such as at the merchant 102. The consumer 112 is also associated with a communication device 114, which is in communication with the network 110. The communication device 114 includes a payment application, whereby the payment credential (e.g., the token, etc.) for the consumer's payment account is provisioned to the communication device 114. As such, the communication device 114 is configured to act as a payment device for the consumer's payment account for use in transactions to be funded by the payment account (via operation of the payment application). In addition in this embodiment, the communication device 114 includes a vehicle application 116 (generally indicated by the circle in FIG. 1), which configures the communication device 114 to operate as described herein. The vehicle application 116 may be integrated with, or separate from, the payment application, described above. Regardless, though, the vehicle application 116 itself, while also potentially including the payment credential associated with the consumer's payment account (as described below), does not render the communication device 114 as an actual payment device (e.g., as compared to the payment application which does, etc.). Instead, when appropriate, the vehicle application 116 may pass the payment credential to another device (e.g., the vehicle 118, etc.), which then acts as a payment device associated with the consumer's payment account (but apart from the communication device 114).

With that said, in an exemplary transaction in the system 100 between the consumer 112 and the merchant 102, using the consumer's payment account, the consumer 112 imitates the transaction by presenting a payment device to the merchant 102, for example, at a point-of-sale (POS) terminal, etc. (e.g., a payment card, the communication device 114 acting as a payment device (as enabled by the payment application installed thereon), another enabled payment device as described herein (e.g., the vehicle 118 upon receiving the payment credential from the vehicle application 116, etc.), etc.). In turn, the POS terminal (broadly, the merchant 102) receives, via contact with or via contactless communication (e.g., NFC, Bluetooth, RFID, etc. communication) with the payment device, the payment credential (e.g., the PAN, the representative token therefore, etc.) associated with the consumer's payment account. And, the merchant 102 then communicates an authorization request (e.g., including the payment credential and an amount of the purchase, etc.) to the acquirer 104. The authorization request is transmitted along path A in the system 100, as referenced in FIG. 1. The acquirer 104 communicates the authorization request with the issuer 108, through the payment network 106, such as, for example, through MasterCard®, VISA®, Discover®, American Express®, etc. (which, when the payment credential includes the token, maps the token to the corresponding payment account (and corresponding PAN) and appends the appropriate PAN in the authorization request), to determine whether the payment account is in good standing and whether there is sufficient funds and/or credit to cover the transaction. In response, if approved, an authorization reply (indicating the approval of the transaction) is transmitted back from the issuer 108 to the merchant 102, along path A (via the payment network 106, which may then again replace the PAN with the token), thereby permitting the merchant 102 to complete the transaction. The transaction is later cleared and/or settled by and between the merchant 102, the acquirer 104, and the issuer 108. If declined, however, the authorization reply (indicating a decline of the transaction) is provided back to the merchant 102, along path A, thereby permitting the merchant 102 to halt or terminate the transaction, or request alternative forms of payment.

Transaction data is generated, collected, and stored as part of the above exemplary interactions among the merchant 102, the acquirer 104, the payment network 106, the issuer 108, and the consumer 112. The transaction data includes a plurality of transaction records, one for each transaction, or attempted transaction. The transaction records, in this exemplary embodiment, are stored at least by the payment network 106 (e.g., in a data structure associated with the payment network 106, etc.), but could be stored in other parts of the system 100 and transmitted therebetween as needed or requested.

In various exemplary embodiments, consumers (e.g., consumer 112, etc.) involved in the different transactions herein are prompted to agree to legal terms associated with their payment accounts, for example, during enrollment in their accounts, during installation of payment applications or other applications (e.g., vehicle application 116, etc.) to their communication devices, etc. In so doing, the consumers may voluntarily agree, for example, to allow merchants, issuers, payment networks, etc., to use data collected during enrollment and/or collected in connection with processing the transactions, subsequently for one or more of the different purposes described herein.

With continued reference to FIG. 1, the system 100 includes the vehicle 118. In this exemplary embodiment, the vehicle 118 includes multiple features, which may be adjusted, by the consumer 112 or other user, to cause the vehicle 118 to be tuned and/or personalized to the consumer 112 and/or to one or more other users. For example, the illustrated vehicle 118 includes a seat 124 and a seat position adjustment system/control 126 (generally indicated by the circle in FIG. 1) configured to adjust positioning of the seat 124, such that the consumer 112 is able to raise or lower the seat 124 and/or adjust an angle of a backrest of the seat 124 when in the vehicle 118 (via the control 126). The illustrated vehicle 118 also includes a side mirror 128 and a mirror position adjustment system/control 130 (generally indicated by the circle in FIG. 1) configured to adjust positioning of the side mirror 128, such that the consumer 112 is able to adjust the side mirror 128 of the vehicle 118 when in the vehicle 118 (via the control 130). The vehicle 118 may also (or alternatively) include features related to vehicle entertainment, such as, for example, an entertainment source (e.g., a radio, auxiliary inputs (e.g., a smartphone, etc.), etc.), volume controls, sounds balance/fade controls, etc., such that the consumer 112 is able to set particular entertainment preferences. Further, the vehicle 118 may also (or alternatively) include one or more climate control features, to allow the consumer 112 to alter the temperature in one or more zones of the vehicle 118; navigation features; driving preference features (e.g., driving mode (e.g., comfort, sport, dynamic, etc.), etc.); etc. With that said, it should be appreciated that various other features may be included in the vehicle 118 to provide for the comfort and/or convenience of the consumer 112 or user of the vehicle 118, and others disposed within the vehicle 118.

In addition in this embodiment, the illustrated vehicle 118 includes doors (e.g., door 132, etc.) to allow the consumer 112 or other user of the vehicle 118 to enter and exit the vehicle (or otherwise access the vehicle 118). The doors include corresponding door locks (e.g., door lock 134 associated with the door 132, etc.) configured to either allow such entry (or access) or inhibit such entry (or access), for example, via operation of a control 136 (generally indicated by the circle in FIG. 1) to actuate the door locks to either lock or unlock the doors of the vehicle 118. In connection therewith, the vehicle 118 (for example, via a vehicle controller 120 (generally indicated by the circle in FIG. 1) associated therewith) may operate (in connection with the control 136) to unlock the door(s) of the vehicle 118 (e.g., actuate a lock(s) of the door(s), etc.) to allow the consumer 112 to access the vehicle 118 as desired (and generally as described herein).

In connection therewith, the vehicle 118 includes the vehicle controller 120, which configures the vehicle 118 to control one or more of the vehicle features based on user directions and/or input at the vehicle 118 (e.g., via one or more of the controls 126, 130, and 136; via one or more other controls; directly and independent of any controls; etc.), or even potentially separate therefrom (e.g., separate from the user manually adjusting a seat position while sitting in the vehicle 118 (via control 126), such as via a communication device; etc.), and/or to otherwise operate as described herein. This will be described in more detail hereinafter. In addition, the vehicle controller 120 is configured to interact with the vehicle application 116 installed at the consumer's communication device 114 (e.g., the vehicle application 116 may be associated with or supported by a particular manufacturer of the vehicle 118 whereby the vehicle controller 120 is configured to recognize the vehicle application 116 to facilitate the operations described herein (e.g., the vehicle application 116 is thereby compatible with the vehicle controller 120, etc.), etc.).

While illustrated as a car, the vehicle 118 may include any type of vehicle within the scope of the present disclosure such as, for example, a truck, a motorcycle, a bus, a train, a boat, a subway vehicle, etc. In addition, the vehicle 118 may belong to the consumer 112 or an associate of the consumer 112 (e.g., a friend, an employer, etc.), or the consumer 112 may be associated with the vehicle 118 in one or more other ways (e.g., where the vehicle 118 is a rental vehicle, a taxi cab vehicle, a share-ride vehicle, a work vehicle, etc.) whereby the consumer 112 may be a driver of the vehicle or a passenger in the vehicle 118, but not the owner of the vehicle 118. Specifically, for example, the vehicle 118 (and other vehicles herein) may be shared by the consumer 112 among multiple other users, etc. In addition, it should be appreciated that the circles used to identify the vehicle application 116, the vehicle controller 120, the profile engine 122, and the controls 126, 130, and 136 in FIG. 1 are not indicative of any particular structure and/or positioning thereof, but are generally representative of the presence of the feature in the system 100. The particular structure thereof is generally described next in connection with computing device 200, and may be considered consistent therewith.

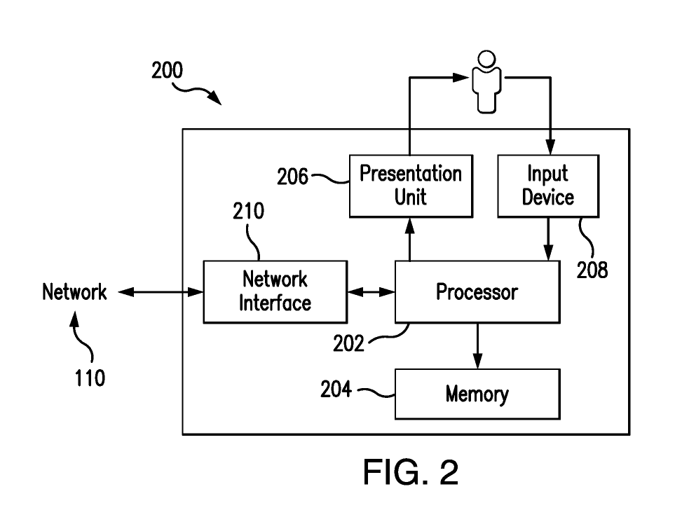

FIG. 2 illustrates an exemplary computing device 200 that can be used in the system 100 of FIG. 1. The computing device 200 may include, for example, one or more servers, workstations, computers, on-board vehicle computers, tablets, laptops, smartphones, PDAs, fobs, fitness tracking wristbands, POS terminals, vehicles, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the merchant 102, the acquirer 104, the payment network 106, and the issuer 108 are illustrated as including, or being implemented in, computing device 200, coupled to the network 110. In addition in the exemplary embodiment of FIG. 1, each of the consumer's communication device 114 and the vehicle 118 (as well as the vehicle controller 120 and the controls 126, 130, and 136 associated therewith) may be considered a computing device, or as including a computing device, consistent with computing device 200. However, the system 100 should not be considered to be limited to the computing device 200, as described below, as different computing devices and/or arrangements of computing devices may be used. In addition, different components and/or arrangements of components may be used in other computing devices.

The exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, user preferences, user profiles, and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information (e.g., loyalty reward incentives, loyalty account totals, etc.), visually or audibly, for example, to a user of the computing device 200, such as the consumer 112 in the system 100 when using the communication device 114 and/or when in or near the vehicle 118; users associated with one or more of the merchant 102, the acquirer 104, the payment network 106, and the issuer 108; etc. And, various interfaces (e.g., as defined by network-based applications such as vehicle application 116, as defined by websites, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 further includes an input device 208 that receives inputs from the user (i.e., user inputs) such as, for example, selections of payment devices and/or payment accounts, etc. The input device 208 is coupled to (and is in communication with) the processor 202 and may include, for example, a keyboard, a pointing device, a mouse, a button, a stylus, a touch sensitive panel (e.g., a touch pad or a touch screen, etc.), a sensor (or a sensor array) (e.g., to detect engine sounds/vibrations, etc.), an RFID reader, another computing device, and/or an audio input device. Further, in various exemplary embodiments, a touch screen, such as that included in a tablet, a smartphone, a vehicle dash, or similar device, behaves as both an output device and an input device. In at least one embodiment, a computing device may omit the presentation unit 206 and/or the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., an NFC adapter, a Bluetooth adapter, a Wi-Fi adapter, etc.), a mobile network adapter, or other device capable of communicating to/with one or more different networks, including the network 110. In some exemplary embodiments, the computing device 200 includes the processor 202 and one or more network interfaces 210 incorporated into or with the processor 202.

Referring again to FIG. 1, the system 100 includes a profile engine 122 (generally indicated by the circle in FIG. 1), which is specifically configured, by executable instructions, to operate as described herein. In general, the profile engine 122 interacts and/or coordinates with the vehicle application 116 at the communication device 114 and/or with the vehicle controller 120 of the vehicle 118 to facilitate the various operations and/or features described herein. It should be appreciated, however, that the operations attributed to the vehicle application 116, the vehicle controller 120 and/or the profile engine 122 may be performed by other ones of the same, or even other, parts of the system 100 in other embodiments. In the illustrated embodiment, the profile engine 122 is provided as part of the payment network 106 (as part of computing device 200 therein, as a separate computing device, etc.). However, the profile engine 122 may be located elsewhere in the system 100 in other embodiments (e.g., as a standalone part of the system 100, etc.).

In particular, the profile engine 122 is configured to generate a profile for the consumer 112, which is specific to the consumer 112 (e.g., in connection with registering the consumer 112 to the vehicle application 116 and/or to the profile engine 122, etc.). The profile may include, for example, consumer-identifying information for the consumer 112 (e.g., the consumer's name, a consumer ID, contact information, etc.), multiple vehicle controls for the consumer 112 (e.g., default controls, preferred controls set by the consumer 112, etc.), and the payment credential(s) associated with the consumer's payment account. The vehicle controls included in the profile may include controls for several features of a vehicle, or they may include controls for only a portion of the available features of a vehicle. As such, each of the vehicle controls included in the profile may correspond to at least one vehicle feature of the vehicle 118 (or of a vehicle in general to which the consumer 112 may have access, etc.). For example, and as described above, a vehicle control may define a seat position feature of a driver seat of the vehicle 118, as preferred by the consumer 112 (e.g., an angle of a seatback, etc.). The profile may include multiple vehicle controls, which may be generic to different types of vehicles (and potentially modified for a particular type of vehicle, or not, when provided to a vehicle as described below) and/or which may be specific to particular types of vehicles. And, the payment credential(s) included in the profile for the consumer's payment account may include, without limitation, the token for the payment account (e.g., provisioned to the communication device 114, etc.), the PAN for the payment account, etc.

It should be appreciated that the profile may include additional or different data in other embodiments.

Once the profile is generated for the consumer 112, the profile engine 122 is configured to store the profile in memory 204 associated with the engine 122 (e.g., in memory 204 associated with the corresponding computing device 200, etc.). However, it should be appreciated that the profile for the consumer 112 may additionally, or alternatively, be stored in the communication device 114 (e.g., in memory 204 of the communication device 114, etc.), in connection with the vehicle application 116, in various embodiments, so that the profile is accessible as described herein (e.g., for sharing with the vehicle 118, for editing/updating by the consumer 112, etc.).

Next in the system 100, when the consumer 112 desires to use the vehicle 118, the consumer 112 approaches the vehicle 118 while possessing the communication device 114. In connection therewith, the vehicle 118 (via the vehicle controller 120) is configured to detect the communication device 114 (via the vehicle application 116), or vice versa (e.g., via Bluetooth™ communication, via Wi-Fi communication (and network 110), etc.), and the communication device 114 is configured (by the vehicle application 116) to solicit an input to authenticate the consumer 112. In particular, for example, the communication device 114 may be configured to solicit a biometric from the consumer 112 (e.g., a fingerprint, etc.), a personal identification number (PIN), or other input from the consumer 112, etc. The communication device 114 is configured to then receive the input from the consumer 112, and to either authenticate the consumer 112 based on a reference stored in the communication device 114 (e.g., a reference biometric, a reference PIN, etc.) (and then communicate such authentication to the vehicle 118, for example, via Bluetooth™ communication, Wi-Fi, etc.) or communicate the received input to the vehicle 118 and/or the profile engine 122 for authentication based on a reference stored therein (based on a reference included in the profile for the consumer 112, which is provided to the vehicle 118 and/or the profile engine 122 in connection with creation of the profile, etc.). With that said, when the communication device 114 is described as configured to perform various operations herein, it should be appreciated that it may be doing so generally in coordination with the vehicle application 116 (even if the application 116 is not specifically referenced), or not.

In connection therewith, the vehicle 118 and/or the profile engine 122 may be configured to maintain a log for the vehicle 118 identifying/classifying the vehicle 118 as being currently “checked out” by a user or currently “available.” When the log indicates that the vehicle 118 is “available,” and when the consumer 112 is authenticated (regardless of where such authentication is performed), the communication device 114 and/or the profile engine 122 is/are configured to provide the profile for the consumer 112 to the vehicle 118. In turn, the vehicle 118 is configured (by the vehicle controller 120) to store the profile (e.g., temporarily in memory 204, etc.) and load the profile to the vehicle 118. In so doing, the vehicle 118 is configured to become accessible to the consumer 112 (e.g., allowing the consumer 112 to unlock the doors (broadly, actuate locks of the doors), automatically unlocking the doors for the consumer 112 (broadly, actuate locks of the doors), permitting ignition start for the vehicle 118, etc.), and to impose each of the vehicle controls included in the profile as available at the vehicle 118. For example, the vehicle 118 is configured (by the vehicle controller 120) to adjust a seat position, when a vehicle control related to the seat position is included in the profile. Again, when the vehicle 118 is described as configured to perform various operations herein, it should be appreciated that it may be doing so generally in coordination with the vehicle controller 120 (even if the vehicle controller 120 is not specifically referenced), or not.

In addition, when the consumer 112 is provided access to the vehicle 118 (and the profile for the consumer 112 is transferred to the vehicle 118), the payment credential for the consumer's payment account is also associated with the vehicle 118 (e.g., provided to the vehicle as part of the profile, etc.) and thereby made available for use by the vehicle 118 in payment account transactions, as described hereinafter (but generally only while the consumer's profile is loaded to the vehicle 118, or only when the consumer's communication device 114 is in communication with the vehicle and/or is not separated from the vehicle 118, etc.). For example, the payment credential for the consumer's payment account (as included in the profile for the consumer 112) may include a token linked to the consumer 112 and only usable when the consumer 112 is authenticated to the communication device 114 and the vehicle 118 (as described above). In connection therewith, the token (and, more generally, the profile for the consumer 112) may only be available to the vehicle 118 when the vehicle 118 is running (e.g., when an engine of the vehicle 118 is running, etc.) or only when the consumer's communication device 114 is within a defined proximity of the vehicle 118 or only when the profile is loaded to the vehicle 118, etc. Then, when the vehicle 118 is turned off and/or the communication device 114 is separated from the vehicle 118, the vehicle 118 (for example, the vehicle controller 120) may be configured to remove/unload the consumer's profile (and the token associated therewith) from the vehicle 118, such that the consumer 112 is required to again authenticate himself/herself to the vehicle 118 in order to continue using the vehicle and/or sharing his/her profile with the vehicle 118 (and make the token again accessible to the vehicle 118). Alternatively (or additionally), the consumer 112 may be able to directly link and unlink the token (and his/her profile) to the vehicle 118 (via particular input to the vehicle application 116, for example), to thereby either associate or disassociate the token to/from the vehicle 118, as desired. As will be appreciated in view of the description hereinafter, both of these options may help facilitate monitoring use of the vehicle 118 and prorating potential costs between different users of the vehicle 118.

Then in the system 100, when the consumer 112 desires to purchase a product from the merchant 102, for example, the vehicle 118 is configured (by the vehicle controller 120) (broadly, as a payment device) to provide the payment credential for the consumer's payment account to the merchant 102. In one example, the transaction may include rental and/or use of the vehicle 118 for a period of time (or a distance), etc. (where the merchant 102 includes a vehicle rental merchant, etc.). Or, the transaction may include purchase of gasoline when the vehicle 118 is present at a gasoline pump (where the merchant 102 includes a fuel merchant, etc.), or it may include a toll transaction as the vehicle 118 passes through a toll gate (where the merchant 102 is a toll merchant, etc.). In any case, the vehicle 118 is configured to provide the token associated with the payment credential for the consumer's payment account to the merchant 102 (e.g., as long as and/or only while the profile is loaded to the vehicle 118, etc.), and the merchant uses the token to generate an authorization request for the transaction (e.g., through the support of Digital Secure Remote Payments (DSRP), etc.) as generally described above (with reference to path A in FIG. 1).

Finally, when the consumer 112 and/or the communication device 114 exit the vehicle 118 or the vicinity of the vehicle 118 (broadly, the communication device 114 is separated from the vehicle 118) (or, in some embodiments, when the vehicle 118 is turned off), the vehicle 118 is configured (by the vehicle controller 120) to unload the profile for the consumer 112 from the vehicle 118, such that the vehicle controls included in the profile no longer control the vehicle features to which they relate (although no alteration of the vehicle features is required (e.g., features do not necessarily return to default settings, etc.)). And, the payment credential for the consumer 112 is no longer available for the vehicle 118 to provide to a merchant.

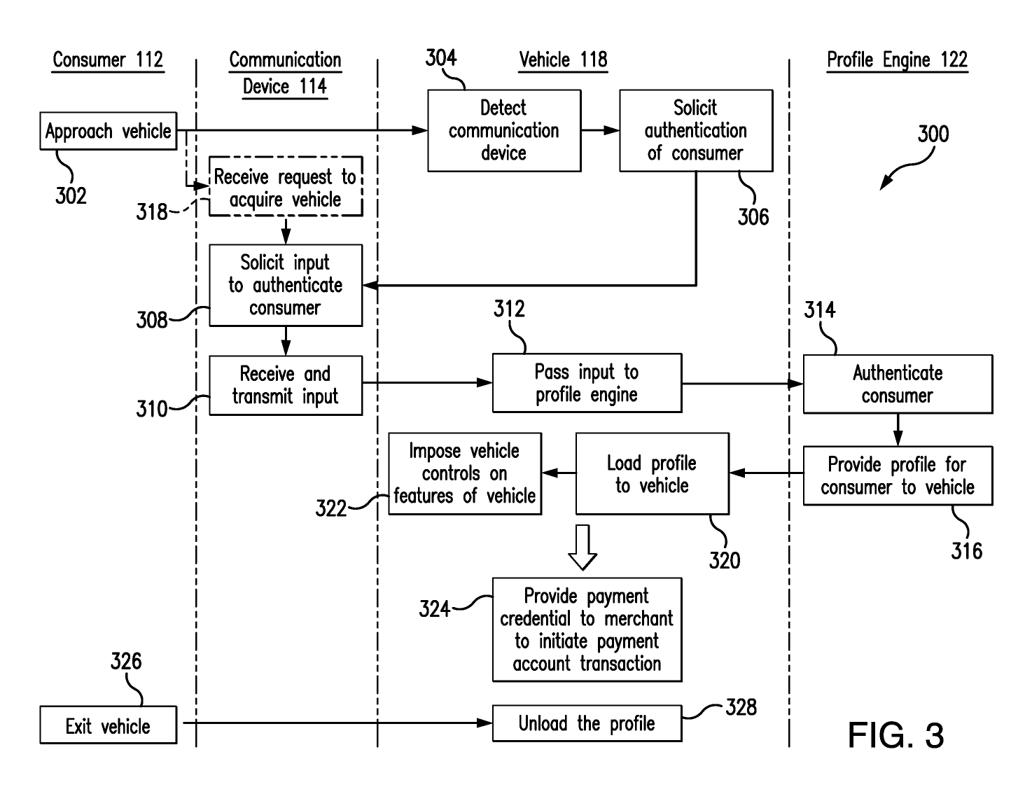

FIG. 3 illustrates exemplary method 300 for use in personalizing a vehicle to a user. The exemplary method 300 is described with reference to the system 100 of FIG. 1 and the computing device 200 of FIG. 2. However, the methods herein should not be understood to be limited to the system 100 and/or the computing device 200 Likewise, the systems and device herein should not be understood to be limited to the method 300. Further, in the exemplary method 300, the vehicle 118 is a shared vehicle, which may be used by multiple users, including the consumer 112. As such, one or more aspects of the method 300 are directed toward the shared nature of the vehicle 118, which may be inapplicable to implementations in which the consumer 112 is the owner and/or sole user of the vehicle 118.

Initially in the method 300, the consumer 112 (with the communication device 114) approaches the vehicle 118, at 302. When the consumer 112 is within proximity of the vehicle 118, the vehicle 118 (via the vehicle controller 120) detects, at 304, the communication device 114 (via the vehicle application 116 installed and/or active therein (e.g., where the vehicle application 116 is compatible with the vehicle controller 120, etc.)).

Upon detecting the consumer's communication device 114, the vehicle 118 (and specifically, the vehicle controller 120) identifies the consumer 112 and attempts to authenticate the consumer 112, at 306. In particular, the vehicle 118 solicits the authentication from the consumer 112, via the communication device 114. In turn, the communication device 114 (and specifically the vehicle application 116) solicits, at 308, an input from the consumer 112, via one or more interfaces at the communication device 114, for use in the authentication of the consumer 112. As described above, such solicitation may include the communication device 114 requesting from the consumer 112 a PIN, a particular biometric (e.g., fingerprint, selfie, etc.), or other information that is unique and/or private to the consumer 112. Regardless, in response, the consumer 112 provides the requested input to the communication device 114. And, the communication device 114 receives the input, at 310, and transmits the input to the vehicle 118 (e.g., via Bluetooth connection, etc.). The communication device 114 may also transmit various consumer-identifying information to the vehicle 118, as necessary and/or as requested, to help further identify the consumer 112 (e.g., a name of the consumer 112, etc.). The vehicle 118, then, passes the input, at 312, to the profile engine 312 for use in authenticating the consumer 112.

Then, upon receipt of the input from the vehicle 118, the profile engine 122 authenticates the consumer 112, at 314. In particular, the consumer 112 is associated with a reference stored at the profile engine 122 (e.g., in memory 204, etc.), such as, for example, a PIN reference, a biometric reference, etc., consistent with the type of input solicited by and received at the communication device 114 (e.g., provided to the profile engine 122 in connection with creation of the profile for the consumer 112, etc.). As such, the profile engine 122 compares the received input to the reference, to determine if there is a match (e.g., an exact match, a substantial match (e.g., for biometrics, etc.), etc. depending on the type of input; etc.). If the received input matches the reference, the profile engine 122 determines the consumer 112 to be authenticated and provides a confirmation thereof and a profile associated with the consumer 112 to the vehicle 118, at 316. However, if the received input does not match the reference, the profile engine 122 determines that the consumer 112 is not authenticated and returns a notification to the vehicle 118 and/or the communication device 114 indicating such (e.g., indicating that authentication has failed and requesting the consumer 112 to retry such authentication, indicating that access to the vehicle 118 is denied, etc.).

It should again be appreciated that authentication of the consumer 112 may occur in various manners, which may involve the profile engine 122 in whole or in part or which may omit the profile engine 122. Specifically, for example, the consumer 112 may be authenticated by and/or at the communication device 114 (as an operation provided by the vehicle application 116, or another application included at the communication device 114). In doing so, the communication device 114 may rely on a reference (e.g., a biometric reference, etc.) included therein, or a reference retrieved via the network 110. Alternatively, the communication device 114 may capture a biometric or other input from the consumer 112 and communicate the same to the profile engine 122, the vehicle controller 120, or other entity associated with authentication of the consumer 112.

In the illustrated method 300, in connection with authenticating the consumer 112, the communication device 114 initially transmits the input received from the consumer 112 to the vehicle 118 (at 310), and the vehicle 118 then transmits the input to the profile engine 122 (at 312). In other embodiments, the communication device 114 may transmit the input directly to the profile engine 122 (at 310) (without the vehicle 118 intermediately receiving the input), for example, when the communication device 114 supports communication with the profile engine 122 via network 110 (e.g., based on permissions and/or configuration (e.g., when not in airplane mode, etc.), etc.).

Additionally, it should be appreciated that the interactions between the communication device 114 and the vehicle 118 may be initiated otherwise than above. For example, the communication device 114 may instead detect the vehicle 118, and then provide an input to the vehicle 118 (at 310) (or directly to the profile engine 122) for use in authenticating the consumer 112 (potentially along with the consumer-identifying information). The detection may be based on the consumer's proximity to the vehicle 118, or it may optionally (as indicated by the dotted lines in FIG. 3) be based on a request, by the consumer 112, at the communication device 114, to acquire the vehicle 118 (as indicated at 318 in the method 300). Thereafter, the communication device 114 solicits an input from the consumer 112 (at 308) for use in authenticating the consumer 112, as described above.

It should also be appreciated that, while in the above description the profile engine 122 authenticates the consumer 112 (or not) (at 314), in other embodiments the consumer 112 may be authenticated otherwise such as, for example, by the communication device 114 and/or by vehicle 118. In such other embodiments, the authentication of the consumer 112 would then be provided to the profile engine 122 (e.g., at 310 and/or 312, etc.), which in turn then provides the profile associated with the consumer 112 to the vehicle 118 (at 316). In still other embodiments, the communication device 114 may authenticate the consumer 112 directly at the communication device 114 (e.g., generally in the same manner as described for the profile engine 122, etc.). In connection therewith, when the consumer 112 is authenticated, the communication device 114 (via the vehicle application 116) may then provide a confirmation of such authentication to the vehicle 118, and also provide the profile for the consumer 112 to the vehicle 118 (instead of the profile engine 122 providing the profile).

With continued reference to FIG. 3, upon receipt of the profile for the consumer 112 from the profile engine 122 (or from the vehicle application 116 at the communication device 114), the vehicle 118 loads the profile to the vehicle 118, at 320. In doing so, the vehicle 118 stores the payment credential (e.g., the token associated therewith, etc.) included in the profile for the consumer's payment account, for use, by the vehicle 118 to facilitate payment account transactions. In addition, the vehicle 118 also identifies available features of the vehicle 118 for which the vehicle controls in the profile are applicable. And, for each identified available vehicle feature, the vehicle 118 imposes, at 322, the particular vehicle control included in the profile for the consumer 112 (e.g., only when the consumer's profile is loaded to the vehicle 118, etc.).

In connection with imposing the vehicle controls from the consumer's profile, in one example, the vehicle profile includes a seat position vehicle control, which is identified to an automated seat positioning feature for the driver's seat of the vehicle 118. In turn, the vehicle 118 recognizes the seat position vehicle control (and its availability in the vehicle 118) and imposes the control to move the driver's seat of the vehicle 118 to the desired/specified position (from the consumer's profile). In another example, the vehicle profile includes a climate vehicle control, which is identified to an automated climate control feature of the vehicle 118. In turn, the vehicle 118 recognizes the climate vehicle control (and its availability in the vehicle 118) and imposes the control to alter the temperature in one or more zones of the vehicle 118 to the desired/specified temperature (from the consumer's profile). In still another example, the vehicle profile includes an entertainment vehicle control, which is identified to an automated entertainment control feature of the vehicle 118. In turn, the vehicle 118 recognizes the entertainment vehicle control (and its availability in the vehicle 118) and imposes the control to alter the radio station, for example, of the vehicle 118 to the desired/specified radio station (from the consumer's profile).

Further, when the consumer 112 is authenticated (at 314) (regardless of location), and the profile is provided to the vehicle 118 (at 316) (regardless of source), the vehicle 118 also provides the consumer 112 with access to the vehicle 118. For example, the vehicle 118 may include one or more doors and one or more corresponding door locks configured to either allow (when unlocked) or inhibit (when locked) access by the consumer 112 (and others) to the vehicle 118 through the one or more doors. In connection therewith, the vehicle (for example, the vehicle controller 120) may operate to automatically unlock the door(s) of the vehicle 118 to allow the consumer 112 to access the vehicle (or, simply allow the consumer 112 to then unlock the doors of the vehicle 118). Also for example, the vehicle may permit the consumer 112 to start the vehicle 118. In this manner, because the vehicle 118, in this example, is a shared vehicle, the use and/or exchange of particular keys and/or fobs for the vehicle may be omitted, because the vehicle 118 relies on the authentication of the consumer 112 and/or the profile to permit access thereto. In at least one embodiment, the profile may include restrictions on the vehicle 118 and/or on other vehicles, such that the consumer 112 is only able to use certain ones of the vehicles and/or certain vehicles at certain times. In permitting access to the vehicle 118, for example, the vehicle 118 will then impose and/or abide by these restrictions and/or rules (as directed by the profile for the consumer 112).

Next in the method 300, as the consumer 112 travels in the vehicle 118, the consumer 112 may desire, or need, to make a purchase at the merchant 102. As such, the consumer 112 drives or otherwise causes the vehicle 118 to be moved into close proximity to or to be present at the merchant 102 (e.g., at a gas pump, through a toll lane, through a drive-thru, etc. depending on the merchant 102). Then, upon a transaction request by the consumer 112 to purchase a product from the merchant 102, the merchant requests (and/or pulls) the payment credential from the vehicle 118, and the vehicle 118 in turn provides, at 324, the payment credential (from the profile) to the merchant 102 in connection with the desired transaction. The merchant 102 then facilitates a payment account transaction for the product, using the payment credential, in the manner described above in the system 100.

Finally in the method 300, when the consumer 112 completes his/her use of the vehicle 118, the consumer 112 leaves the vehicle 118, or more generally, exits the vehicle 118, at 326. In response, the vehicle 118 detects the absence of the communication device 114, for example, and proceeds to unload the profile, at 328, from the vehicle 118. In so doing, the vehicle 118 halts imposition of any vehicle controls from the profile, although that does not necessarily mean the vehicle 118 will change any vehicle feature to a default or other position/setting, etc. For example, upon halting imposition of the vehicle controls, the vehicle 118 may leave the vehicles features as defined by the vehicle controls in the profile for the consumer 112, until a different profile is loaded or a user manually alters the vehicle features. In addition in unloading the profile, the payment credential is also removed from the vehicle 118 such that it is no longer able to be provided to the merchant 102 or any merchant in connection with the purchase.

In addition to the above, the vehicle 118 may permit more than one consumer to be associated with the vehicle 118, such that multiple profiles are loaded to the vehicle at one time. In connection therewith, a primary-secondary relationship may be defined for the vehicle 118, between the multiple profiles, for example, based on the first profile loaded, etc. In this way, the vehicle controls of the first profile will take precedent and be imposed, when in conflict with vehicle controls of the second (or subsequent) profile(s). What's more, in connection with multiple different payment credentials being present for the multiple different profiles, the vehicle 118 may (via presentation unit 206 or other output device associated therewith, or the communication device 114, etc.) request a selection of one payment credential for a given transaction (or for all transactions), or a division of a purchase amount of a transaction among one or more of the different payment credentials (via a division factor (e.g., 50%; 75%; 50:50; 25:25:50; etc.), thereby providing shared payment and/or flexibility in utilizing the payment accounts associated with the different consumers.

As an example, the vehicle 118 may be associated with the merchant 102 (e.g., where the merchant is a vehicle rental merchant, etc.), and the use of the vehicle 118 by the consumer 112 may provide the basis for a payment account transaction between the consumer 112 and the merchant 102. In such an embodiment, either before entering the vehicle, or after use, the vehicle 118 provides the consumer's payment credential (as obtained from the profile for the consumer 112) to the merchant 102 along with an hourly rate, miles, etc. associated with usage of the vehicle 118, and any identifying information about the consumer 112 necessary to perform the transaction, whereby a transaction for a charge to use the vehicle 118 is initiated. Then, when a second consumer is included in the vehicle 118, with an additional profile loaded thereto for the secondary consumer, the consumer 112 may have the option, as described above, to divide the transaction amount for the use of the vehicle 118 between his/her payment account and a payment account of the secondary consumer, by submission, for example, of two transactions to the merchant 102 totaling the full amount charged for the use of the vehicle 118.

Thus, the systems and methods herein allow for vehicles to be personalized to users in connection with use of the vehicles by the users. In connection therewith, after initial authentication of the users to vehicles, various predefined user preferences are provisioned to (and imposed on) the vehicles. What's more, payment credentials for the users may also be provisioned to the vehicles, whereby the vehicles may then be used by the users as payment devices. Such personalization is available to the users regardless of whether the vehicles are individual to the users or are shared with other users. Then, when the users are done using the vehicles, the user preferences and payment credentials may be unloaded from the vehicles, such that the vehicles may be similarly used by subsequent users (taking into account their particular user preferences and payment credentials).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) soliciting authentication of a user to a vehicle, the user associated with a payment account; (b) after receiving authentication of the user, loading a profile associated with the user to the vehicle, the profile including a payment credential associated with the payment account and at least one vehicle control; (c) imposing the at least one vehicle control on a feature of the vehicle to thereby alter the feature of the vehicle; (d) providing, by the computing device, the payment credential to a merchant in connection with a transaction associated with the vehicle; (e) unloading the profile when a communication device associated with the user is separated from the vehicle and/or when the vehicle is turned off; (f) unlocking a door of the vehicle and permitting access of the user to the vehicle after authentication of the user; (g) authenticating a second user to the vehicle, the second user associated with a second payment account; (h) after authenticating the second user, loading a second profile associated with the second user to the vehicle, the second profile including a payment credential associated with the second payment account; and (i) receiving a division factor from the user and/or the second user for use in the transaction.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the exemplary embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle for use by a user to travel from location to location, the vehicle comprising:
at least one control for managing at least one feature of the vehicle; and
a vehicle controller computing device in communication with the at least one control and configured to:
detect a communication device associated with the user and solicit authentication of the user to the vehicle, the user associated with a payment account;
when the user is authenticated, load a profile associated with the user, the profile including a payment credential associated with the payment account and at least one vehicle control setting;
alter, via the at least one control, the at least one feature of the vehicle based on the at least one vehicle control setting included in the loaded profile; and
provide the payment credential, from the user profile, to a merchant in connection with a transaction initiated by the user, such that the payment credential is only provided to the merchant, from the vehicle, when the user profile is loaded to the vehicle.

2. The vehicle of claim 1, wherein the vehicle includes a seat and a side mirror; and
wherein the at least one feature includes an angle of a backrest of the seat and/or an angle of the side mirror.

3. The vehicle of claim 2, wherein the vehicle controller computing device is further configured to unload the profile when a communication device associated with the user is separated from the vehicle and/or when the vehicle is turned off.

4. The vehicle of claim 2, wherein the vehicle controller computing device is further configured to receive an authentication input associated with the user from the communication device associated with the user, in connection with soliciting the authentication of the user, and to transmit the authentication input to a profile engine, whereby the authentication input is compared to a reference to authenticate the user; and
wherein the vehicle controller computing device is configured, in connection with loading the profile, to receive the profile from the communication device associated with the user after the user is authenticated.

5. The vehicle of claim 4, wherein the payment credential includes a payment token provisioned to the communication device associated with the user.

6. The vehicle of claim 1, further comprising a door and a lock associated with the door; and
wherein the vehicle controller computing device is configured to actuate the lock to permit access of the user to the vehicle via the door, after the user is authenticated.

7. A computer-implemented method for use in personalizing a vehicle to a user, the computer-implemented method comprising:
soliciting authentication of a user to a vehicle, the user associated with a payment account;
after receiving authentication of the user, loading, by a computing device, a profile associated with the user to the vehicle, the profile including a payment credential associated with the payment account and at least one vehicle control;
imposing, by the computing device, the at least one vehicle control on a feature of the vehicle to thereby alter the feature of the vehicle; and
providing, by the computing device, the payment credential to a merchant in connection with a transaction associated with the vehicle.

8. The computer-implemented method of claim 7, further comprising unloading, by the computing device, the profile when a communication device associated with the user is separated from the vehicle.

9. The computer-implemented method of claim 7, further comprising unloading, by the computing device, the profile when the vehicle is turned off.

10. The computer-implemented method of claim 7, wherein the at least one vehicle control includes one or more of a position of a seat included in the vehicle and an entertainment setting.

11. The computer-implemented method of claim 7, wherein the feature includes a navigation feature of the vehicle, and wherein the at least one vehicle control includes a driving preference of the user.

12. The computer-implemented method of claim 7, further comprising, in connection with soliciting authentication of the user, passing an authentication input from a communication device associated with the user to a profile engine, the authentication input based on a biometric of the user; and
wherein loading the profile to the vehicle includes receiving the profile from one of the communication device associated with the user and the profile engine, upon authentication of the user.

13. The computer-implemented method of claim 12, wherein the payment credential includes a payment token provisioned to the communication device associated with the user.

14. The computer-implemented method of claim 12, wherein the merchant includes an operator associated with the vehicle; and
wherein the transaction includes a rental transaction associated with the user's use of the vehicle.

15. The computer-implemented method of claim 14, further comprising unlocking a door of the vehicle, by the computing device, and permitting access of the user to the vehicle after authentication of the user.

16. The computer-implemented method of claim 12, further comprising:
soliciting authentication of a second user to the vehicle, the second user associated with a second payment account;
after receiving authentication of the second user, loading, by the computing device, a second profile associated with the second user to the vehicle, the second profile including a payment credential associated with the second payment account; and
receiving, at the computing device, a division factor from the user and/or the second user; and
wherein providing the payment credential further includes providing the second payment credential and the division factor, whereby the transaction is funded between the payment account and the second payment account based on the division factor.

17. The computer-implemented method of claim 7, wherein soliciting authentication the user includes authenticating, by the computing device, a biometric received from a communication device associated with the user.

18. The computer-implemented method of claim 7, wherein the merchant includes one of: a toll operator, a gasoline station, and a drive-thru restaurant.

19. A non-transitory computer-readable storage media including computer-executable instructions for personalizing a vehicle to a user, which, when executed by a processor, cause the processor to:
authenticate a user to a vehicle, the user associated with a payment account;
when the user is authenticated, load a profile associated with the user to the vehicle, the profile including a payment credential associated with the payment account and at least one vehicle control;
impose the at least one vehicle control on a feature of the vehicle to thereby alter the feature of the vehicle;
provide the payment credential to a merchant in connection with a transaction associated with the vehicle only when the user profile is loaded to the vehicle; and
unload the profile from the vehicle when a communication device associated with the user is separated from the vehicle and/or when the vehicle is turned off.

20. The non-transitory computer-readable storage media of claim 19, wherein the computer-executable instructions, when executed by the processor, further cause the processor to:
authenticate a second user to the vehicle, the second user associated with a second payment account;
when the second user is authenticated, load a second profile associated with the second user to the vehicle, the second profile including a payment credential associated with the second payment account; and
receive a division factor from the user and/or the second user; and
wherein the computer-executable instructions, when executed by the processor, cause the processor, in connection with providing the payment credential to the merchant, to further provide the second payment credential to the merchant and the division factor, whereby the transaction is funded between the payment account and the second payment account based on the division factor.
